(19) United States
(12) Patent Application Publication
(10) Pub. No.: US 2008/0046340 A1
(43) Pub. Date: Feb. 21, 2008

(54) Method and system for protecting domain names via third-party systems

(76) Inventor: Charles P. Brown, Chicago, IL (US)

Correspondence Address: Lesavich High-Tech Law Group, P.C., Suite 325, 39 S. LaSalle Street, Chicago, IL, 60603, US

(21) Appl. No.: 11/891,699

(22) Filed: Aug. 13, 2007

Related U.S. Application Data
(63) Continuation-in-part of application No. 09/876,408, filed on Jun. 7, 2001.
(60) Provisional application No. 60/210,660, filed on Jun. 9, 2000.

(51) Int. Cl. G06Q 30/00; G06F 17/30; G06F 17/40

(52) U.S. Cl. 705/26; 707/104.1

(57) ABSTRACT

A method and system for extending a permanent domain name registration service and/or website hosting service by third-party payment system. A third-party payment system enables a domain name/website hosting account holder to accept third-party payments; third parties may then view a payment section on their website and choose to make a payment for a specified period. The third-party payment system manages the funds and tracks the need to accept third-party payments and to make timely payments to the service provider. A beneficiary contact and a third-party contact method are included as means to help manage a website that may operate unattended and may remain online indefinitely thereby providing permanent domain name registration or permanent website hosting.

### CROSS REFERENCES TO RELATED APPLICATIONS

This application is a Continuation-In-Part of U.S. application Ser. No. 09/876,408 filed on Jun. 7, 2001, that claims priority to U.S. Provisional Application, 60/210,660, filed Jun. 9, 2000, the contents of all of which are incorporated by reference.

### COPYRIGHT NOTICE

Pursuant to 37 C.F.R. 1.71(e), applicants note that a portion of this disclosure contains material that is subject to and for which is claimed copyright protection, such as, but not limited to, screen shots, user interfaces, or any other aspects of this submission for which copyright protection is or may be available in any jurisdiction. The copyright owner has no objection to the facsimile reproduction by anyone of the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### FIELD OF THE INVENTION

This invention relates to domain name identifiers used on a computer network. More specifically it relates to a method and system for extending domain name registration service website hosting service with a third-party payment system.

### BACKGROUND OF THE INVENTION

A domain name is a textual name that identifies one or more Internet Protocol (“IP”) addresses on a computer network like the Internet, an intranet or other computer network. As is known in the art, IP is a routing protocol designed to route traffic within a network or between networks. An IP address is issued in the format X.X.X.X, where each X represents a number between zero and 255. For example an IP address for of 128.132.103.43 may be issued for a network server.

The domain name “chuckbrown.net” may identify the IP addresses 139.142.203.45 and 139.142.203.46. Domain names make it easier for people to identify sites on the Internet and other computer networks. If a textual domain name is not used, then a person would have to remember or memorize many different IP addresses to locate sites or information on the Internet or other computer networks.

Domain names are used by people in Uniform Resource Locators (“URLs”) to identify particular web-sites on the Internet or other computer networks. Since sites on the Internet and other computer networks are identified by IP addresses and not domain names, web servers typically require assistance from a Domain Name Servers (“DNS”) to translate domain names into IP addresses.

A domain name has a suffix that indicates which top-level domain (“TLD”) it belongs to. There are only a limited number of TLDs including: (1) “.com,” for commercial business; (2) “.edu,” for educational institutions; (3) “.gov,” for government agencies; (4) “.mil,” for the military; (5) “.net,” for network organizations and (6) “.org,” for organizations including non-profit organizations. There have been recent proposals to add new TLDs including “.biz,” for businesses, “.firm,” for professional organizations such as law firms, accounting firms, and others.

Network Solutions, Inc. (“NSI”) under contract with the National Science Foundation was the exclusive registrar of TLD's from 1993-1998. The Internet Corporation for Assigned Names and Numbers (“ICANN”) was established in 1998 to move the administration of the DNS to the private sector. There are now many different approved organizations that can register domain names in association with ICANN. For example, a domain name can be registered electronically at nsi.com, register.com, namedroppers.com, domainnameregistration.com, budgetregister.com and other web-sites on the Internet.

There are a number of problems associated with the current system of registering domain names. One problem is that the current system of registration fees for Global TLDs is designed to ensure that there is money available each year from each domain to contribute to the support of the registry/registrar system and the DNS. To achieve the purpose of ensuring funding and that each domain contributes to the system each year. This system establishes a monetary self-sufficiency for the registration system, but at the cost of administrative overhead and business risk for the users of the system.

Another problem is that the pre-eminence of the dot-com (“.com)” TLD has created a de facto single global jurisdiction for trademark use. Instead of traditional common law trademark rights, which allows separate rights based on geographical separation, legitimate trademark holders can be restricted from using their trademark in the dot-com domain because someone else got it first or because another party with a conflicting trademark claim has more money to fight any trademark dispute in the courts. There are no technical barriers to allow multiple common law trademark holders sharing a domain name, but there are barriers within the current system of domain registration with the all-or-nothing ownership of domain names.

Another problem is that the current system of Internet domain ownership does not confer ownership in the traditional sense of the word. What is now referred to as “domain name ownership” is really just a right to use a domain, provided that the registration fee is current. An entity that “owns” a domain name retains the right to use that domain name by paying the registration fee on time. Otherwise the usage rights to the domain name are forfeited and the domain name returns to the general pool of domain names available for anyone to register and acquire usage rights.

Another problem is that domain names have become valuable entities unto themselves, far out of proportion in value to the cost of an annual registration fee. Some domains have a commercial value of millions of dollars, but non-payment of a single $35 payment can result in the loss of valuable rights and will disconnect a web-site at a domain name address.

Another problem with the current system of renewing domain names is that it places a high administrative cost on domain name owners to track and issue small payments. Large corporations typically have many domain names with administrative and payment contacts spread throughout divisions and departments. This distributed rather than centralized control increases the chances of one or more domains could expire. In addition, individuals listed as administrative and payment contacts could leave an organization thereby preventing the proper individual to be timely located to handle problems with, or renewals of, domain names.

Another problem is that there is no system of accountability or defined procedures for the registrars to guarantee that the renewal notices for a domain are ever issued or received to ensure that the individuals responsible for the domain are notified. In the case of no response to a renewal notice, there are no procedural guarantees are in place to protect the rights of the domain name owner. There is also a lack of survivorship or beneficiary rights from the domain name registrars for individual domain name holders who die.

Another problem is the maintenance of domain rights beyond the term of currently paid registration fees. The current domain name registration system currently sends renewal notices via electronic mail (“e-mail”). In today's society, individuals frequently change Internet Service Providers, and hence frequently change e-mail addresses. In addition, even business organizations may change e-mail addresses due to mergers, acquisitions, buyouts, re-organizations, bankruptcy, etc. If a domain name owner changes e-mail addresses between registration periods, the possibility exists that the domain name payment notice will not be received, increasing the possibility of the registration period lapsing.

Another problem is that Internet Service Providers (“ISP”) and other organizations that host web-sites associated with a domain name frequently go out of business. Many domain name owners would like the ability to maintain a permanent web-site on the Internet without regard to the underlying web-site host.

Another problem is that under the current system of domain rights, domain ownership or access rights exist on an all-or-nothing basis. The named registrant has all rights to the use of the domain name and any web or e-mail address that is in that domain. Therefore, there is limited opportunity to take advantage of additional possible uses of domain name registrations.

Another problem is that under the current system of investment in domain names, domain registrants offer domains for sale either directly or through domain reseller web sites such as GreatDomains.com or Afternic.com. These sites handle thousands of sales, but all sales are for a full interest in the domain and require a transfer of the domain from the investor to the new registrant. The current system defines an inefficient market based on an all-or-nothing ownership structure that does not allow ownership interests in domain names to be shared by multiple parties.

Another problem is the danger of hacking or tampering or errors at the registrar or registry level. Domain names have been hacked or hijacked from legitimate owners. Even when the domain names can be recovered, substantial fees including legal fees can be incurred by the legitimate owner.

Website hosting is defined as a document or documents that may be HTML, scripts, graphics or other format that are reachable over a communications network via network protocols and viewable on that network at the address or addresses associated with a domain name identifier. Website hosting is differentiated from a web page hosting in that a website is associated with its own domain name, while a web page resides on the shared domain that's primary function is not providing an address for that particular web page.

Website hosting and domain registration services normally have an account associated with them that is used to manage the service options and pay for the services. Domain names can be registered for 1-10 years through ICANN-authorized registrars. Website hosting payment plans can vary from month-to-month to multi-year. When payments are missed, the service terminates. In the case of domain names, it may result in the loss of control of the domain name if another party registers the name after it expires. In the case of website hosting, it may result in the loss of files and data. In any case, missed payments can result in the loss of service. In the case where the account holder lacks either the funds or the access or the presence to make the payment, the loss of service can be permanent.

Individuals and organizations create websites for many different reasons and the standard payment options offered by service providers do not satisfy all requirements in the market. There are many methods to making timely payments, two common ones being automatic credit card payments and regular email reminder notifications. These methods work for many websites, but not for all. Ultimately, someone needs to make the payments. There needs to be timely payments going to the service provider or the service will terminate.

With some websites, there may be a shared community responsibility or interest that goes beyond the interest or involvement of the website creator. Some examples of websites like this are those dedicated to a political cause, a fan website, or a personal memorial website. Some websites may be unfunded or unattended, by design or by circumstance. It is impractical to provide every potential member of the community access to the website account holder's account in order to make payments to the service provider.

There are websites that accept donations to fund operations, but they accept donations as general funds and allocate them to expenses as they deem appropriate. These scenarios imply that there is an organization or individual behind the scenes that accepts the donations and applies them to general expenses, and not specifically to maintaining the website.

Another problem that exists with the current system of domain registration accounts and website hosting accounts is that if an account holder becomes unable to fulfill the ownership role of account holder, because of death for example, friends, relatives and associates who may have an interest in assuming the account holder role can be restricted from access. Domain name registrations and websites have been lost for this reason.

Thus, it is desirable to provide a method to permanently protect and utilize domain name registrations. The method should help prevent a domain name owner from ever losing valuable domain name rights and fully utilize existing and new rights associated with a domain name registration.

### SUMMARY OF THE INVENTION

In accordance with preferred embodiments of the present invention, some of the problems associated with protecting domain names are overcome. A method and system for protecting domain names via third party payment systems is presented.

The method and system described herein extend a permanent domain name registration service and/or website hosting service with a third-party payment system. A third-party payment system enables a domain name/website hosting account holder to accept third-party payments; third parties may then view a payment section on their website and choose to make a payment for a specified period. The third-party payment system manages the funds and tracks the need to accept third-party payments and to make timely payments to the service provider. A beneficiary contact and a third-party contact method are included as means to help manage a website that may operate unattended and may remain online indefinitely, thereby providing permanent domain name registration or permanent website hosting.

The foregoing and other features and advantages of embodiments of the present invention will be more readily apparent from the following detailed description. The detail description proceeds with references to accompanying drawings.

### BRIEF DESCRIPTION OF THE DRAWINGS

Embodiments of the present invention are described with reference to the following drawings, wherein:

FIG. 1 is a block diagram illustrating an exemplary domain name protection system;

FIG. 2 is a flow diagram illustrating a method for protecting domain name registrations with a permanent registration certificate;

FIGS. 3A and 3B are a flow diagram illustrating a method for providing permanent registration of domain name registrations;

FIG. 4 is a block diagram illustrating an exemplary data flow associated with the method of FIG. 3;

FIG. 5 is a flow diagram illustrating a method for providing a permanent web-site;

FIG. 6 is a flow diagram illustrating a method for providing a co-use of a permanent domain name;

FIG. 7 is a block diagram illustrating a third-party payment system for extending the service period of domain name registration and website hosting;

FIG. 8 is a block diagram of screen shot of a graphical user interface for an account holder to accept third-party payments for the purpose of extending domain name registration service and website hosting service;

FIG. 9 is a screen shot of a graphical user interface for an account holder that has activated third-party payments for the purpose of extending domain name registration service and website hosting service;

FIG. 10 is a screen shot of a graphical user interface for viewing third-party payment report for an account holder that is accepting third-party payments for the purpose of extending domain name registration service and website hosting service;

FIG. 11 is a screen shot of a graphical user interface that allows potential third-party payers to view information regarding third-party payments and to choose to make a payment;

FIG. 12 is a screen shot of a graphical user interface that collects payment information from the third-party payer, including the payment amount and term;

FIG. 13 is a screen shot of a graphical user interface that prompts the third-party payer to confirm the payment information;

FIG. 14 is a flow diagram illustrating a method for choosing to accept third-party payments;

FIG. 15 is a flow diagram illustrating a method of a third-party payer making a payment to extend the service term of the account holder;

FIG. 16 is a flow diagram illustrating a method of a third-party payment system accepting a payment and checking to see if a service payment is required before forwarding payment to the service provider;

FIG. 17 is a flow diagram illustrating a method of a third-party payment system accepting a payment and disabling acceptance of third-party payments if the accumulated payment balance for that account holder has reached its maximum.

FIG. 18 is a flow diagram illustrating a method for maintaining payments in perpetuity;

FIG. 19 is a flow diagram illustrating another method for maintaining payments in perpetuity;

FIG. 20 is a flow diagram illustrating a method for establishing an account beneficiary; and

FIG. 21 is a block diagram illustrating a system for maintaining a third-party contact.

### DETAILED DESCRIPTION OF THE PRESENT INVENTION

Exemplary Domain Name Protection System

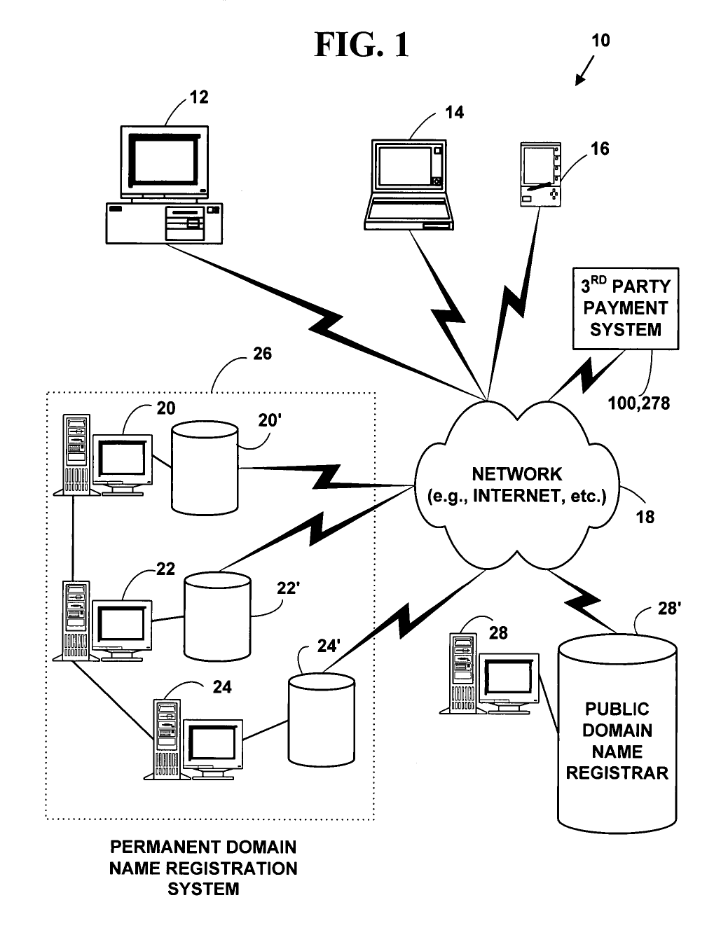

FIG. 1 is a block diagram illustrating an exemplary domain name protection system 10. The exemplary domain name system 10 includes one or more client network devices 12, 14, 16 (only three of which are illustrated). The client network devices 12, 14, 16 include, but are not limited to, personal computers, wireless devices, mobile phones, personal information devices, personal digital assistants, hand-held devices, network appliances, pagers, and other types of electronic devices. However, the present invention is not limited to these devices and more or fewer types of client electronic devices can also be used. The client network devices 12, 14, 16 are in communications with a computer network 18 (e.g., the Internet, intranet, etc.). The communication includes, but is not limited to, communications over a wire connected to the client network devices, wireless communications, and other types of communications.

Plural server network devices 20, 22, 24 (only three of which are illustrated) are associated with one or more associated databases are components of a permanent domain name registration system 26. The permanent domain name registration system 26 includes a Purchase/Payment server 20, an Administrative server 22 and a Web-site hosting server 24. The plural network devices 20, 22 and 24 provide system for allowing a “permanent registration” of a domain name. However, more or fewer server network devices can also be used and the present invention is not limited to the illustrated components.

In addition, the plural server network devices are illustrated as separate network devices and the functionality of the server network devices can be split into additional servers, or combined into fewer servers. The plural server network devices 20, 22, 24 may also include duplicate or “mirrored” server network devices with associated plural databases to provide fault tolerance.

In another embodiment of the present invention, the plural server network devices 20, 22, 24 can also be combined into one server network device with associated plural databases. In such an embodiment, the single server network device and associated plural databases would include the necessary functionality to protect registered domain names and may include a duplicate or “mirrored” server network device with associated plural databases to provide fault tolerance.

The Purchase/Payment server 20 accepts domain name registration information and handles payment of current and future renewal fees for a domain name. The administrative server 22 helps ensures that the payment has been received by the public domain name registrar by checking for the updated next payment date, verifying payments, determining and solving payment and information discrepancies, etc. The Web-site hosting server 24 allows a domain name for which a permanent registration has been obtained to have a permanent presence on the computer network 18. Thus, the Web-site hosting server 24 can “permanently” host a web-site.

An operating environment for components of the domain name protection system 10 for preferred embodiments of the present invention include a processing system with at least one high speed Central Processing Unit (“CPU”) and memory. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by the CPU. The computer readable medium includes cooperating or interconnected computer readable medium, which exist exclusively on the processing system or be distributed among multiple interconnected processing systems that may be local or remote to the processing system.

Protecting a Domain Name Registration

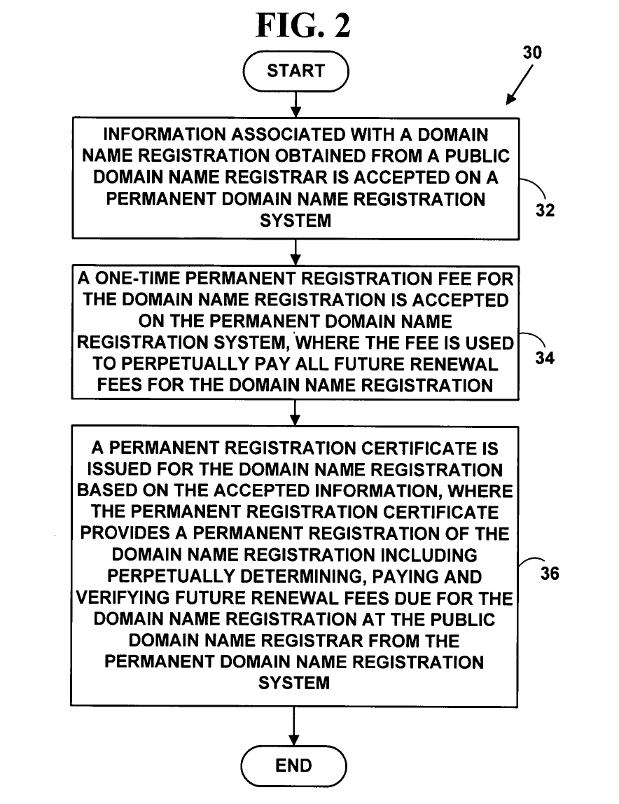

FIG. 2 is a flow diagram illustrating a Method 30 for protecting domain name registrations with a permanent registration certificate. At Step 32, information associated with a domain name registration obtained from a public domain name registrar is accepted on a permanent domain name registration system. At Step 34, a one-time permanent registration fee for the domain name registration is accepted on the permanent domain name registration system. At Step 36, a permanent registration certificate is issued for the domain name registration based on the accepted information. The permanent registration certificate provides a permanent registration of the domain name registration including perpetually determining, paying and verifying future renewal fees for the domain name registration at the public domain name registrar from the permanent domain name registration system.

Method 30 may also comprise any or all of the additional steps of: issuing a domain name registration title, issuing an insurance policy, issuing plural ownership shares, issuing leases or sub-leases, issuing co-ownership certificates, or creating new or additional rights in the domain name associated with the permanent registration certificate.

The domain name registration title (“Domain Title”) covers financial losses associated with not properly renewing a domain name registration. The Domain Title can be used alone, or in combination with the insurance policy. In one embodiment of the present invention, the Domain Title is implemented as a contract. However, the present invention is not limited to such an embodiment, and other embodiments can also be used.

The insurance policy covers financial losses associated with not properly renewing a domain name registration. The insurance policy provides compensation for any financial losses associated with accidental disruption or loss of domain name rights use. The insurance policy also allows trustees and/or beneficiaries for permanent domain name registrations to be named to ensure that the wishes of domain name registration holder are honored, regardless of situations resulting from inaction, disability or death.

The plural ownership shares allow ownership interests to be sold in the permanent domain name registration. In one embodiment of the present invention, the plural shares are implemented as contracts designed to support the specific features of equity sharing, co-ownership or “stock” ownership in domain names. However, the present invention is not limited to such an embodiment, and other embodiments can also be used.

Multiple share owners with defined shared rights could co-exist in a similar way. For example, in the world of real estate, condominium or apartment owners share clearly defined ownership rights with other owners within a larger property which in itself is a separate legal entity. The holder of shares can sell shares in a domain name to investors for income or appreciation or to make many types of ownership and sharing of domain names possible in ways that are not currently viable.

Issuing leases or sub-leases for a domain name associated with the permanent registration certificate allows ownership interests to be reserved for a limited duration in a domain name registration associated with the permanent registration certificate. The holder of a Domain Title could lease the use of the domain name or portions of it to another entity for a period of any length, while providing rights including renewal rights and right of first refusal. Such a system of leasing could not be considered reliable under the current system because the current “right holder” could not guarantee their ability to confer those rights beyond the term of currently paid domain name registration fees.

Issuing co-ownership certificates for the domain name associated with the permanent registration certificate allows two or more entities in two or more different locations to co-own one domain name registration associated with the permanent registration certificate. For example, two common law trademark owners located in different parts of the U.S. or in different parts of the world could co-own a domain name registration.

In one embodiment of the present invention, creating new or additional rights includes creating additional contract layers on top of the permanent domain name registration system 26. This new contract layers may require a third-party to guarantee the new or additional rights associated with the permanent registration certificate can be enforced.

Method 30 is illustrated with an exemplary embodiment. However, the present invention is not limited to this exemplary embodiment and other embodiments can also be used with Method 30.

At Step 32, information associated with a domain name registration obtained from a public domain name registrar 28 such as NSI, or other ICAAN approved registrar is accepted on the permanent domain name registration system 26. In another embodiment of the present invention, the information can also be accepted from a private domain name registrar (e.g., a private domain name registrar for an intranet or other private computer network). In another embodiment of the present invention, the permanent domain name registration system 26 could also accept information from a user and issue its own domain name registration for either a public or a private network 18. In another embodiment of the present invention, the permanent domain name registration system 26 could also obtain a domain name registration from a public domain name registrar for a user.

In one embodiment of the present invention, the accepted information includes the domain name, domain name owner, address, domain name server information and other information. However, more or fewer types of information can be accepted and the present invention is not limited to this list.

In one embodiment of the present invention, at Step 32 a user enters required information regarding a registered domain name that is accepted into the Purchase/Payment server 20. In another embodiment of the present invention, the Purchase/Payment server 20 accepts required information directly from the public domain name registrar 28.

In one embodiment of the present invention, the Purchase/Payment server 20 dynamically checks the information with the appropriate public domain name registrar after it has been accepted. The information is checked to determine if the information is accurate, has not been tampered with, or has not been altered without explicit notification or permission of either the original domain name registrant and/or the public domain name registrar 28. This provides an additional security measure for the permanent domain name registration system 26.

At Step 34, a one-time permanent registration fee for the domain name registration is accepted on the permanent domain name registration system 26. In one embodiment of the present invention, Step 34 includes accepting a one-time permanent registration fee electronically over the Internet 18 on Purchase/Payment server 20. The fee is accepted electronically by accepting credit-card information, debit-card information, checking account information, electronic funds transfer information, or other types of electronic payment or e-commerce payment information.

In another embodiment of the present invention, the fee can be accepted by administrative or support personal via telephone by collecting appropriate credit or debit information from a user. In another embodiment of the present invention, the fee can be accepted via check, money order, etc. sent via the U.S. mail, express mail, etc. In embodiments where the one-time permanent registration fee is not accepted electronically, the permanent registration certificate described below is not issued until the fee payment has been verified (e.g., waiting for a check to clear, etc.).

In one embodiment of the present invention, the one-time permanent registration fee is added to financial instruments whose profits or interest is used to perpetually pay future renewal fees for the domain name registration. For example, the financial instrument can include an interest bearing account, a certificate of deposit, mutual funds, stocks, bonds, annuities, or other type of financial instrument.

In one embodiment, the one-time permanent registration fee is selected such that a first portion of the fee will be used to satisfy current registration fees and administrative costs at the public domain name registrar 28. A second portion of the fee is enough to generate interest or other income through investments and/or the sale of additional goods or services to pay all current and future administrative costs and future registration fees in perpetuity for the domain name registration on the permanent domain name registration system 26. One skilled in the art can determine that the one-time permanent registration fee can be divided into various other portions that are distributed in various ways to cover costs and fees on the permanent domain name registration system 26 and the public domain name registrar 28.

In one embodiment of the present invention, the one-time permanent registration fee is selected based on contractual or other agreements with one or more public domain name registrars. For example, a first user may have obtained a domain name registration from a first public domain name registrar that has a contractual agreement with the permanent domain name registration system 26 owners. The first public domain name registrar may have agreed to allow renewal of a domain name registrar perpetually for $10 per year. The one-time permanent registration fee would then be selected based on the $10 per year renewal fee. If a second public domain name registrar agreed to allow renewal of domain names it registered for $8 per year, a different one-time permanent registration fee could be selected. Various types of contractual or other legal agreements between public domain name registrars and the permanent domain name registration system 26 allow the one-time permanent registration fee to be variable and flexible.

The accepted information is stored in one or more databases 20′, 22′ and/or 24′ associated with the permanent domain name registration system 26. Table 1 illustrates exemplary information accepted and stored for a domain name registration. However, the accepted and stored information is exemplary only and more or less information can also be stored.

TABLE 1

Permanent Registration Certificate Number: 13579246
Insurance Policy Number: xxx
Domain Title Number: xxx
Domain Share Certificate Number: xxx
Payment Account Number: xxx
Lease/Sublease Number: xxx
Co-User Number: xxx
Co-Owner Number: xxx
Contract Number: xxx
Registrar(s): xxx
US Domain Name: permanentweb.com
Administrative Contact: Chuck Brown
Hamlin Computer Technology, Inc.
5100 Hamlin Avenue
Chicago, Illinois 60625 US Phone-773-463-2051 Fax-
Technical Contact: Thomas Brown
Global Logistics Corp Domain Management Division
Port Vila, 1 VU
Phone—+64 21-360-006
Fax—+1-801-749-2901
Record updated on 2000-08-24 00:00:00.
Record created on 2000-08-24.
Record expires on 2001-08-24.
Database last updated on 2001-05-31 10:13:36 EST.
Domain servers in listed order:
NS.BULKREGISTER.COM 216.147.43.234
NS2.BULKREGISTER.COM 216.147.1.164

At Step 36, a permanent registration certificate is issued for the domain name registration. The permanent registration certificate provides a permanent registration of the domain name registration including perpetually determining, paying and verifying future renewal fees for the domain name registration at the public domain name registrar 28 from the permanent domain name registration system 26.

In one embodiment of the present invention, an electronic permanent registration certificate is created from the accepted information and forwarded to the domain name owner electronically. The electronic permanent registration certificate is stored on one or more databases 20′, 22′, 24′ associated with the permanent domain name registration system 26. The electronic permanent registration certificate can be viewed via computer network 18 (e.g., with a web-browser). Access to the electronic permanent registration certificate may be limited to the domain name owner(s) and protected by one or more security measures (e.g., login, password, encryption, etc.).

In another embodiment of the present invention, a paper permanent registration certificate is issued at Step 38. The accepted information used to create the paper permanent registration certificate is stored on one or more databases 20′, 22′, 24′ associated with the permanent domain name registration system. The paper permanent registration certificate is then forwarded to the domain name owner for safekeeping. However, the present invention is not limited to such embodiments and the present invention can be used with other types of permanent registration certificates.

Method 30 enables domain name owners to establish permanent rights to a domain name registration and provide a process to help reduce the risk that a domain name registration will lapse because of error or inaction, or other unforeseen circumstances.

Providing Permanent Registration of Domain Names

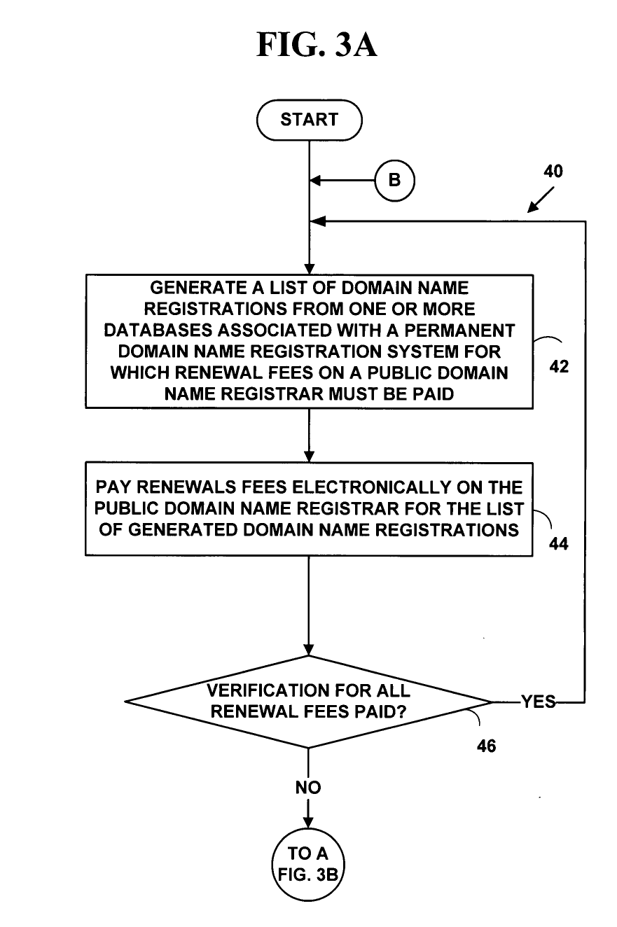

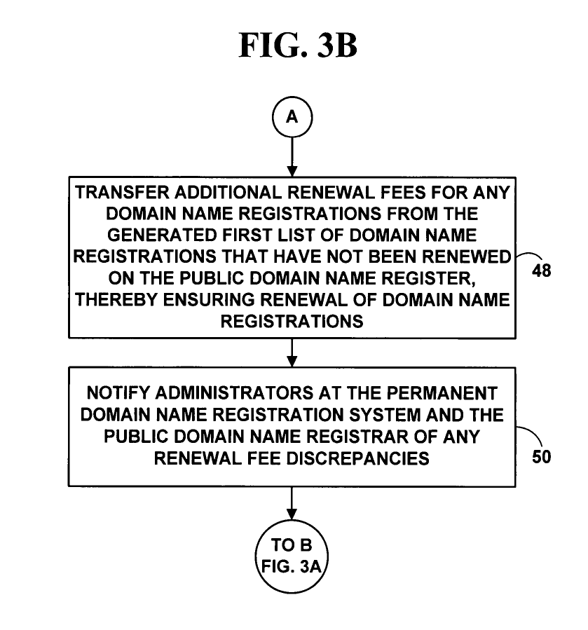

FIGS. 3A and 3B are a flow diagram illustrating a Method 40 for providing permanent registration of a domain name registrations. In FIG. 3A at Step 42, a list of domain name registrations is generated from one or more databases associated with a permanent domain name registration system for which renewal fees on a public domain name registrar must be paid. The generated list of domain name registrations includes plural domain name registrations for which plural permanent registration certificates have been purchased. The permanent registration certificate provides a permanent registration of the domain name registration including perpetually determining, paying and verifying current and future renewal fees for the domain name registration at the public domain name registrar from the permanent domain name registration system. At Step 44, renewals fees are paid electronically on the public domain name registrar for the list of generated domain name registrations. At Step 46, a query is conducted at the public domain register to determine whether all of the domain name registrations from the generated list of domain name registration have been renewed on the public domain name registrar.

If all of the domain name registration have not been renewed on the public domain registrar, then in FIG. 3B at Step 48, additional renewal fees are transferred for any domain name registrations that have not been renewed on the public domain name registrar, thereby ensuring renewal of domain name registrations. At Step 50, administrators at the permanent domain name registration system and the public domain name registrar are notified of any renewal fee discrepancies. Steps 42-46 are repeated periodically and perpetually to ensure that all domain name registrations on the permanent domain name registration system are properly renewed.

If all of the domain name registration have been renewed on the public domain registrar at Step 46, then Steps 42-46 are repeated periodically and perpetually to ensure that all domain name registrations on the permanent domain name registration system are properly renewed.

Method 40 is illustrated with an exemplary embodiment. However, the present invention is not limited to this exemplary embodiment and other embodiments can also be used with Method 40.

At Step 42, a list of domain name registrations is periodically generated from one or more databases 20′ 22′ 24′ associated with a permanent domain name registration system 26 for which renewal fees on a public domain name registrar 28 must be paid.

The permanent domain name registration system 26 maintains lists of domain name registrations and ensures that payments are transferred to an appropriate public domain name registrar 28 in advance of the due date without fail. The permanent domain name registration system 26 is based on redundant databases with checks and balances and automatic pre-payment and verification of registration fees. The permanent domain name registration system helps reduce or even eliminate any possibility of an accidental domain name registration deletion or non-payment. The permanent domain name registration system 26 also helps satisfy requirements of an insurance company that may be issuing business interruption insurance associated with the permanent registration certificate.

In one embodiment of the present invention, the permanent domain name registration system 26 cross-checks domain name registration information from three databases 20′, 22′ and 28′ and generates the list at Step 42. One database is a Purchase/Payment Database 20′. Another database is an Administration Database 22′. These two databases 20′ and 22′ are maintained by the permanent domain name registration system 26. The third database 28′ is a database maintained by public domain name registrar 28 that issues the actual domain name registrations. The third database 28 may be multiple databases for one public domain name registrar, or multiple databases for multiple public domain name registrars. The third database 28′ may also include one or more database for a private domain name registrar.

In one embodiment of the present invention, the Purchase/Payment and Administration databases 20′, 22′ will have separate administrators and controls to ensure that an error on the part of one server, database or person will not result in a lost domain name registration or a missed payment. Automatic messages will be sent to the administrators of all three databases in the case of any discrepancies between the databases. These messages will be repeated until the problem has been resolved. The destinations, frequency and escalation procedures for those messages are configurable.

In one embodiment of the present invention, the Purchase/Payment database 20′ maintains a full list of covered domain name registration and renewal dates and is responsible for generating payment lists at Step 42 for upcoming months and for receiving the renewal notifications from the public domain name registrar 28. However, the present invention is not limited to this embodiment and other components of the permanent domain name registration system 26 can generate lists at Step 42.

In one embodiment of the present invention, the Purchase/Payment server 20 generates list of renewals due in the next month from the Purchase/Payment database 20′ For example, renewals due in May will be generated by the first day of April.

The Administrative database 22′ also includes a list of all covered domain name registration with the information included in the Purchase/Payment database 20′. In addition, this database includes full client account information including login security information and account history.

The third database 28′ is an existing external database maintained by the public domain name registrar 28. The data it maintains is includes information returned by a “whois ” check on a domain name. As is known in the art, whois is an Internet-based directory service for looking up names of owners of domain name registrations.

Returning to FIG. 3A at Step 44, renewals fees are paid electronically on the public domain name registrar for the list of generated domain name registrations. In another embodiment of the present invention, renewal fees can be paid by other methods as was described above for accepting payment for a permanent registration certificate (e.g., via the telephone, via the U.S. mail, etc.). The present invention is not limited to paying renewal fees electronically.

The renewal fees paid at Step 44 can be paid in a number of different manners based on a number of different factors. In one embodiment, the renewal fees are paid electronically only for domain name registrations that will expire in the next month. In another embodiment of the present invention, the renewal fees are paid electronically for all domain name registration that will expire in a pre-determined time period (e.g., 3 months). In another embodiment of the present invention, the additional renewal fees are also paid electronically when a value of a renewal fee account at the public domain name registrar falls below a pre-determined amount.

The payment system may also include an advanced payment balance or buffer at each public domain name registrar 28 or selected public domain name registrars. The purpose of the advanced buffer is to ensure that the enough money will be on hand for the registrar to draw down from as the covered domains come due. The buffer will provide an additional level of assurance that in the case of a missed payment by the

Administrative server 22 and/or Purchase/Payment server 20, and/or the public domain name registrar 28 will still be able to draw the required payment from the excess funds in the payment buffer. When the payment system checks the balance of the payment buffer and finds a discrepancy, the database administrators will be notified and required to find the reason for the missed payment or missed domain name and make the corrections and balance the account.

At Step 46, a query is conducted at the public domain register 28 to determine whether all of the domain name registrations from the generated list of domain name registrations have been renewed on the public domain name registrar 28.

In one embodiment of the present invention, the Administrative server 22 conducts the query at Step 46. However, the present invention is not limited to such an embodiment and the query conducted at Step 46 can be conducted from other components of the permanent domain name registration system 26.

In one embodiment of the present invention, the query at Step 46 is conducted on databases on the permanent domain name registration system 26 and on the public domain name registrar 28. In such an embodiment, the results are compared to immediately determine an inconsistencies and the appropriate database administrators are notified.

If there are any domain names from the list that have not be marked as renewed by the public domain name registrar 28, the Administrative server 22 flags any such domain names. The Administrative server 22 sends a message to the Purchase/Payment database 20′ to transfer the additional funds to the public domain name registrar 28.

At Step 48 of FIG. 3B, additional renewal fees are transferred by the Purchase/Payment server 20 for any domain name registrations that have not been renewed on the public domain name registrar 28, thereby ensuring renewal of domain name registrations. At Step 50, the Administrative server 22 notifies administrators at the permanent domain name registration system 26 and the public domain name registrar 28 of any renewal fee discrepancies.

If the query at Step 46 shows that all of the domain name registrations from the generated list of domain name registrations have been renewed on the public domain name registrar 28, then processing continues periodically at Step 42 of FIG. 3A.

If the Administrative database 22′ includes any domain name registrations that it shows as expiring in the following month for which the public domain name registrar 28 does not show a renewal fee is due, the Administrative server 22 sends a message to the Purchase/Payment database 20′ to transfer the additional funds. Additionally, administrators for both databases are notified of the discrepancy.

In one embodiment of the present invention, at the end of each month, the Purchase/Payment server 20 optionally checks the balance in the public domain name registrar account 54 to verify that an expected balance is present. However, the present invention is not limited to this embodiment. In the case of an unexpected balance, both administrators are notified.

Steps 42-46 (FIG. 3A) are repeated on a periodic basis. For example, weekly a series of automated checks will be run to verify that the public domain name registrar database 28′, the Purchase/Payment database 20′ and the Administrative database 22′ are all in agreement with respect to domain name registrations and renewal dates. If any discrepancies are found, the respective administrators are notified. However, the present invention, is not limited to a weekly series of automated checks and virtually any larger or smaller time period could be used to repeat Steps 42-46 (e.g, minutes, hours, days, etc.).

The integrity of the permanent domain name registration system 26 is also monitored frequently. Public domain name registrar databases 28′ are also monitored frequently to determine any changes made by a domain name owner. Any determined changes are propagated to, or corrected in databases 20′, 22′, 24′ in the permanent domain name registration system 26 and/or public domain name registrar database 28′. Public domain name registrar databases 28′ and databases 20′, 22′, 24′ are also monitored frequently to determine if any improper changes have been made by hackers or hijackers.

Exemplary data flow for providing permanent registration of domain names

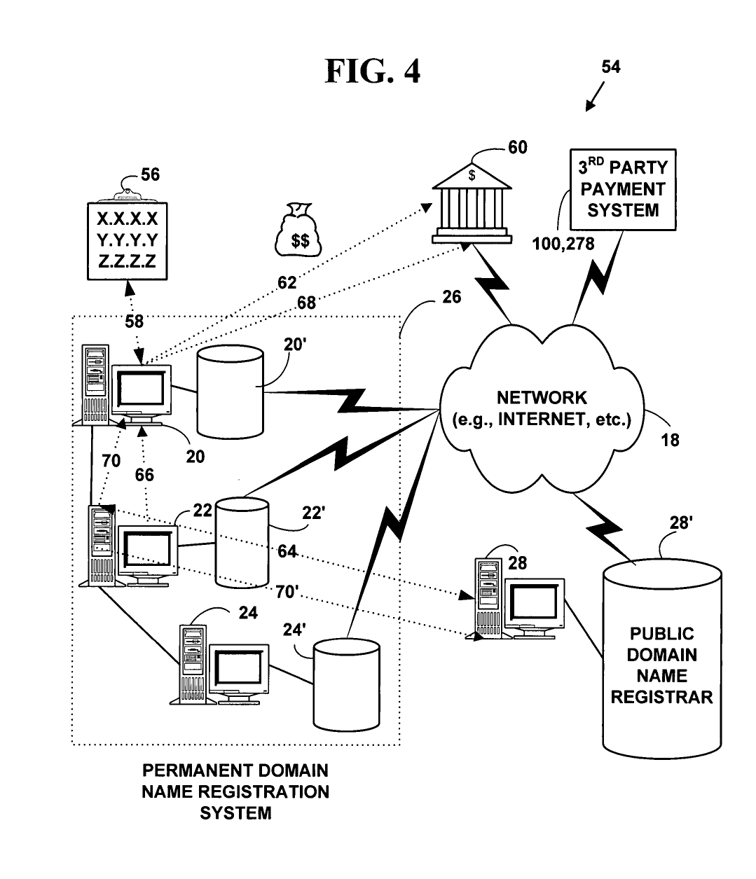

FIG. 4 is a block diagram illustrating an exemplary data flow 54 associated with Method 40 of FIG. 3. In FIG. 3A at Step 42, a list of domain name registrations 56 is generated by the Purchase/Payment Server 20 from one or more databases 20′, 22′ and 24′ associated with a permanent domain name registration system 26 for which renewal fees on a public domain name registrar 28 must be paid. This is illustrated by Line 58.

At Step 44, renewals fees are paid electronically to an account 60 for the public domain name registrar 28 for the list of generated domain name registrations 56. This is illustrated by Line 62.

At Step 46, a query is conducted from the Administrative Server 28 at the public domain register 28 to determine whether all of the domain name registrations from the generated list of domain name registrations 56 have been renewed on the public domain name registrar 28. This is illustrated by Line 64.

If there are any domain names from the list that have not be marked as renewed by the public domain name registrar 28, the Administrative server 22 flags any such domain names. The Administrative server 22 sends a message to the Purchase/Payment server 20 to transfer the additional funds to the public domain name registrar 28. This is illustrated by Line 66.

At Step 48 of FIG. 3B, additional renewal fees are transferred by the Purchase/Payment server 20 for any domain name registrations that have not been renewed on the public domain name registrar 28, thereby ensuring renewal of domain name registrations. This is illustrated by Line 68. At Step 50, the Administrative server 22 notifies the Purchase/Payment Server 22 at the permanent domain name registration system 26 and the public domain name registrar server 28 of any renewal fee discrepancies. This is illustrated by lines 70 and 70′.

Providing a Permanent Web-Site for Permanently Registered Domain Names

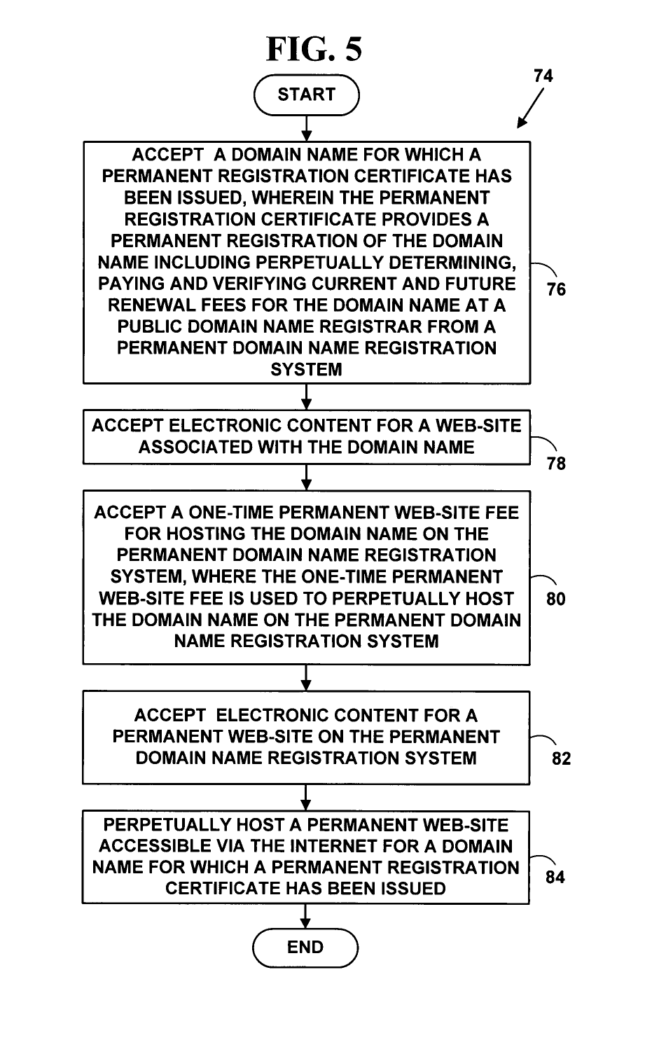

FIG. 5 is a flow diagram illustrating a Method 74 for providing a permanent web-site. At Step 76, a domain name for which a permanent registration certificate has been issued is accepted on a permanent domain name registration system. The permanent registration certificate provides a permanent registration of the domain name including perpetually determining, paying and verifying current and future renewal fees for the domain name at a public domain name registrar from the permanent domain name registration system. At Step 78, electronic content for a web-site to be associated with the domain name is accepted. At Step 80, a one-time permanent web-site fee for hosting the domain name on the permanent domain name registration system is accepted. The one-time permanent web-site fee is used to perpetually host the domain name on the permanent domain name registration system. At Step 82, a web-site accessible via the Internet associated with the domain name is perpetually hosted on the permanent domain name system.

Method 74 is illustrated with an exemplary embodiment. However, the present invention is not limited to this exemplary embodiment and other embodiments can also be used with Method 74.

At Step 76, a domain name for which a permanent registration certificate has been issued is accepted on the permanent domain name registration system 26. The permanent registration certificate provides a permanent registration of the domain name including perpetually determining, paying and verifying current and future renewal fees for the domain name at a public domain name registrar from the permanent domain name registration system. For example, a permanent registration certificate issued via Method 30 (FIG. 2).

At Step 78, electronic content for a permanent web-site to be associated with the domain name is accepted on the permanent domain name registration system 26. In one embodiment of the present invention, the electronic content is accepted via permanent web-site server 24 and stored in one or more permanent web-site databases 24′. The electronic content accepted includes text, graphics, audio, video, and other electronic content.

At Step 80, a one-time permanent web-site fee for hosting the domain name on the permanent domain name registration system 26 is accepted via the Purchase/Payment database 20′. The payment is recorded on the Administrative database 22′. The one-time permanent web-site fee is used to perpetually host the domain name on the permanent domain name registration system 26.

As is known in the art, hosting a web-site includes providing hardware and software necessary to allow communications with the Internet and to service request/responses for electronic content on the web-site. In one embodiment of the present invention, the one-time permanent web-site fee is added to a financial instrument whose profits or interest is used to perpetually pay administrative costs to host a web-site for the domain name accessible via the Internet on the permanent domain name system. However, the present invention is not limited to such an embodiment.

At Step 82, a permanent web-site accessible via the Internet 18 associated with the domain name is perpetually hosted on the permanent domain name system 26. The perpetual hosting of the web-site helps provide a “permanent” presence on the Internet via a domain name by perpetually maintaining a web-site associated with the domain name and perpetually determining, paying and verifying current and future renewal fees for the domain name at a public domain name registrar from the permanent domain name registration system using a permanent registration certificate issued for the domain name.

In one embodiment the permanent web-site is hosted directly by the permanent web-site server 24 on the permanent domain name registration system 26.

In another embodiment of the present invention, the “permanent web-site” is not hosted from the permanent domain name registration system 26. In such an embodiment the permanent web-site is hosted by another host. However, the permanent domain name registration system 26 continually monitors the host to ensure the host is viable and has is not having problems or has gone out of business.

In another embodiment of the present invention, the permanent web-site server 24 hosts the domain name associated with the permanent web-site (e.g., by accepting queries to a published IP address), but maps or otherwise re-directs any queries from the computer network 18 to an appropriate host that is actually hosting the permanent web-site.

The permanent web-site server 24 also frequently monitors the host to update any new content stored on the permanent web-site. In one embodiment of the present invention, any new content added to the permanent web-site must be sent to the permanent web-site server 24 by the permanent web-site. In another embodiment of the present invention, the permanent web-site server 24 automatically monitors the permanent web-site and automatically downloads and stores any new content in the permanent web-site database 24′ to keep the permanent web-site database up-to-date. If the host is having problems or has gone out of business, the permanent web-site is then immediately hosted via permanent web-site server 24.

If a host is having problems or has gone out of business, the IP address identifying the domain name for the permanent web-site at the host can be immediately re-mapped to a new IP address on the permanent web-site server 24. Thus, the permanent web-site can be permanently hosted by the permanent domain name registration system 26 in a variety of different ways.

Co-Using a Permanent Domain Name

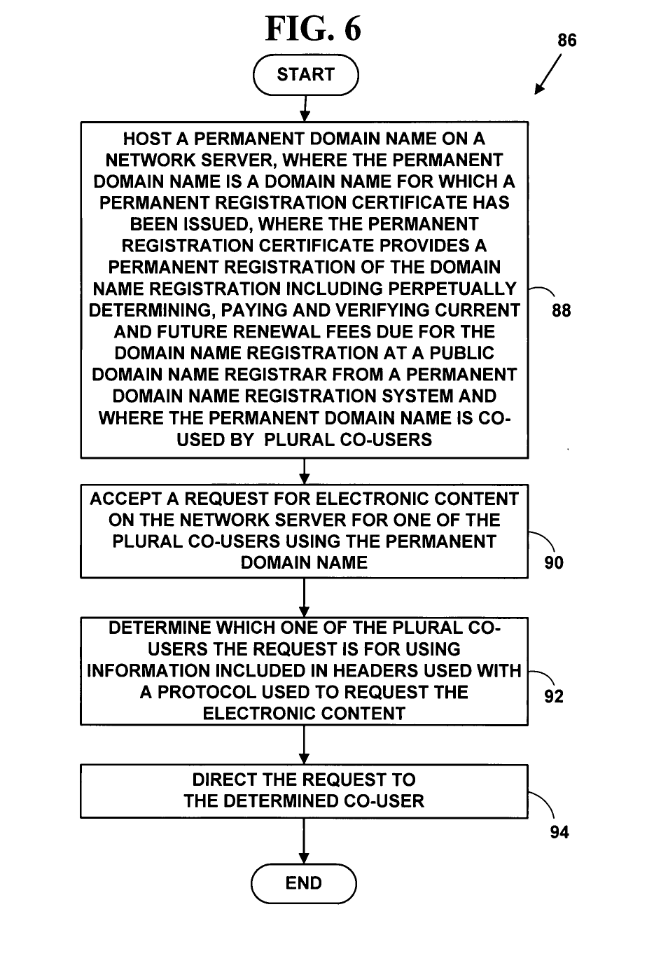

FIG. 6 is a flow diagram illustrating a Method 86 for providing a co-use of a permanent domain name. At Step 88, a permanent domain name is hosted on a network server. The permanent domain name is a domain name for which a permanent registration certificate has been issued. The permanent registration certificate provides a permanent registration of the domain name registration including perpetually determining, paying and verifying current and future renewal fees due for the domain name registration at a public domain name registrar from a permanent domain name registration system. The permanent domain name is co-used by plural co-users. At Step 90, a request for electronic content is accepted on the network server for one of the plural co-users using the permanent domain name. At Step 92, a determination is made to determine which one of the plural co-users the request is for using information included in headers used with a protocol used to request the electronic content. At Step 94, the request is directed to the determined co-user.

The plural co-users can be co-owners of the permanent domain name. The plural co-users can also be leasing or sub-leasing the permanent domain name for one or more permanent domain name owners. Co-ownership and leasing/sub-leasing of a permanent domain name was discussed above.

Method 86 is illustrated with an exemplary embodiment. However, the present invention is not limited to this exemplary embodiment and other embodiments can also be used with Method 86.

In such an embodiment at Step 88, a permanent domain name is hosted on the Web-site hosting server 24. The permanent domain name is a domain name for which a permanent domain name registration certificate has been issued (e.g., with Method 30 of FIG. 2). The permanent domain name is co-used by plural co-users. At Step 90, a request for electronic content is accepted on the Web-site hosting server 24 for one of the plural co-users using the permanent domain name. At Step 92, a determination is made to determine which one of the plural co-users the request for electronic content is for using information included in headers used with a protocol used to request the electronic content. In one embodiment of the present invention, the determination made at Step 92 includes making a determination using an IP address in a header for a protocol used to request the electronic content. However, the present invention is not limited to such an embodiment and other determinations can also be used at Step 92.

In one embodiment of the present invention, the protocol used the electronic content can include, but is not limited to, the Hyper Text Transfer Protocol (“HTTP”), File Transfer Protocol (“FTP”), Simple Mail Transfer Protocol (“SMTP”), a variety of other protocols from the Internet Protocol suite, or other types of networking protocols.

In one embodiment of the present invention, the Web-site hosting server 24 maintains tables for co-users of a permanent domain name. The tables include specific IP addresses or ranges of IP addresses for which a co-user of a permanent domain name will accept requests for electronic content. These tables allow two or more co-users to co-use the same permanent domain name from different geographic regions, or based on other pre-determined criteria (e.g., cooperative agreements, contracts, advertising or other fees, etc.). At Step 94, the request is directed to the determined co-user by the Web-site hosting server 24.

In one embodiment of the present invention, Method 86 helps allow co-use of a permanent domain name, thus helping to reduce trademark disputes or other business disputes. Business disputes can also be resolved with Method 86 by a neutral third-party outside the permanent domain name owners, the permanent domain name registration system 26 or the public domain name registrar 28.

As an example, to reduce trademark disputes, suppose a first co-user was using a permanent domain name in based on a common law trademark in Illinois and a second co-user was using the same permanent domain name in California. The Web-site hosting server 24 could then use pre-determined IP addresses or ranges of IP addresses to determine whether a request is for the first or second co-user. The IP addresses are used to determine a geographic region the request came from, and then direct the request to the co-user that in the geographic region closest to the requester. Conflicts are resolved with a pre-determined set of rules or sending the information to a default co-user.

Third-Party Payment System for Permanent Domains and Websites

A method and system to provide permanent domain registration systems allowing payments for a domain name registration service and/or a website hosting service directly by a third-party payment system, which makes payments to a service provider, either immediately or as needed, without access to the website account or the website account holder. An unattended website could remain online indefinitely.

The method and system allows websites to have their terms extended, potentially indefinitely, without intervention by the account holder to accept funds and make sure that payments are made.

The third-party payers may be displayed on the third-party payment section of the website. This provides acknowledgement of those who have contributed, and possibly peer pressure within the community for others to contribute. Payers have the option to remain anonymous while making their payment.

Since the payments from third-party payers will almost certainly not synchronize with the due dates, the present invention includes methods for the third-party payment system to accumulate payment funds, and through an accounts database track the balance, track due dates, amounts due, payments made, received and scheduled, and any other data that may be considered useful in maintaining a third-party payments system. If a third-party payment is received and the payment system determines that a payment is not required at that time, the funds can be invested to generate income. The payment system monitors the account balance, the amount due and the due date to ensure that payments are made to the service provider in a timely fashion. When a certain threshold of accumulated funds is reached that will allow the payment system to make the necessary payments in perpetuity from the income generated by the accumulated funds.

In one embodiment, a permanent domain registration and a permanent website that allows payment of service fee via a third-party payment system is used as memorial website for a deceased person or pet that is maintained perpetually and in perpetuity for the deceased person or pet as a memorial website. However, the present invention is not limited to this embodiment and other embodiments may also be used to practice the invention.

One example of such an embodiment is a memorial website, which is used for illustration, the present invention is not limited to use with memorial websites. Methods of memorialization frequently outlive the person or people responsible for establishing them. Headstones in cemeteries are made to last for hundreds of years and cemeteries offer perpetual care funds for maintaining grave sites. The method and system described herein provide a permanent website that may be used as an “electronic headstone” on the Internet or other computer network.

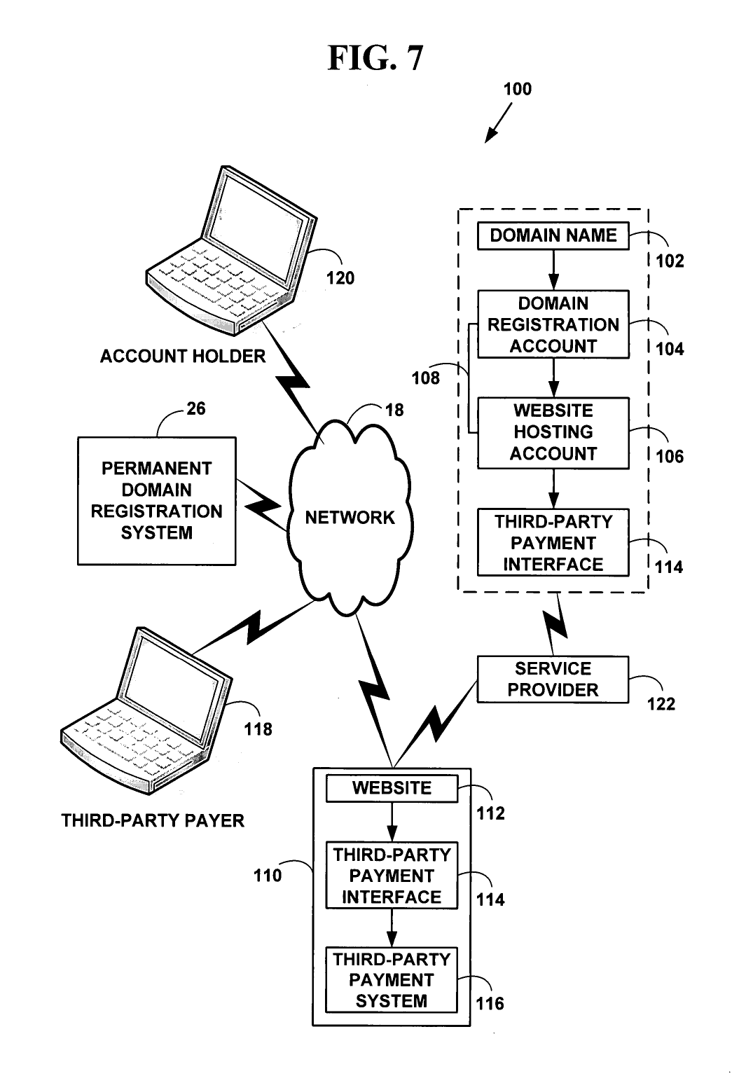

FIG. 7 is a block diagram illustrating an exemplary third-party payment system 100 for extending the service periods of domain name registration and website hosting. The system 100 includes, but it not limited to a communications network 18 that interconnects the components, a domain name 102, a domain registration account 104 and website hosting account 106, or a combined domain registration and website hosting account 108. A third-party payment system 110 includes a website 112 that resides at the address indicated by the associated domain name 102 including a third-party interface 114 with functionality to process third-party payments 116. One or more third-party payers 118 and an account holder 120 who is responsible for the domain name registration 102 and the website 104 that is hosted on it. A service provider 122 provides the underlying service to the account holder that maintains domain name accounts and the websites and access to them. The third-party contact system 278 also includes the domain name protection systems 10 and dataflow 54 (FIGS. 1 and 4).

In one embodiment, the website 112 of the account holder is a memorial website for a deceased person or pet that is maintained perpetually and in perpetuity for the deceased person or pet as a memorial website. However, the present invention is not limited to this embodiment and other embodiments may also be used to practice the invention.

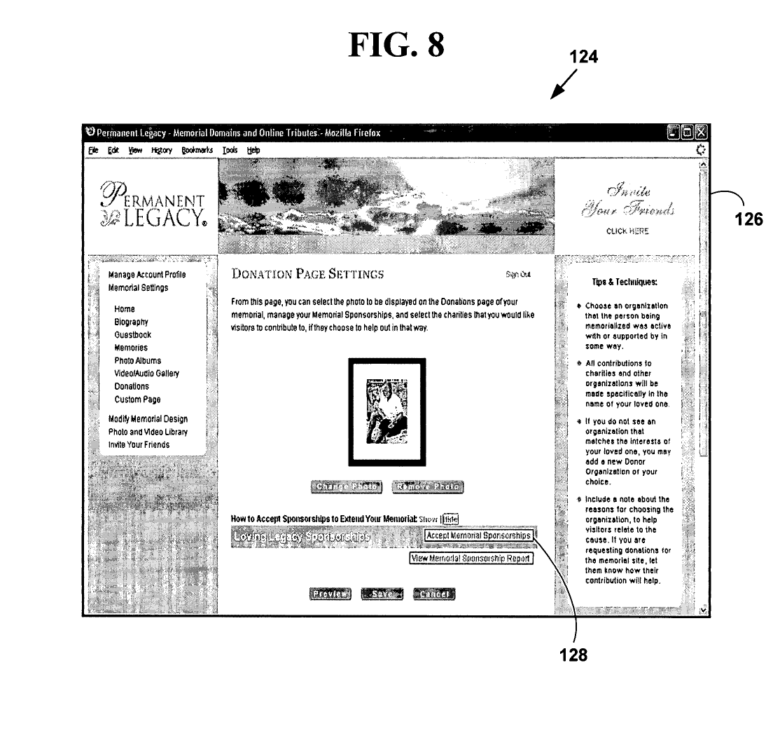

FIG. 8 is block diagram of a screen shot 124 of a graphical user interface (GUI) 126 that allows an account holder to accept third-party payments for the purpose of extending domain name registration service and website hosting service. The control button 128 labeled “Accept Memorial Sponsorships” will activate third-party payments for this account holder when pressed.

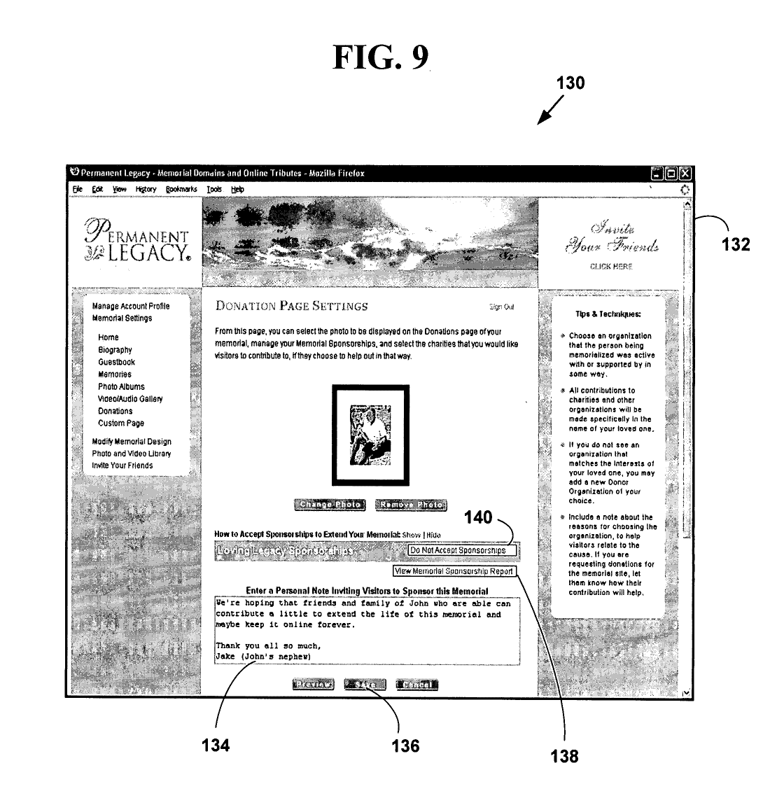

FIG. 9 is a block diagram 130 of a screen shoot 132 from the GUI 126 that shows the interface after third-party payments have been activated. The account holder may enter in a message that will be displayed to potential third-party payers in the text box 134 and confirm and save the settings by pressing the Save button 136. The account holder may view a third-party payment report by clicking on the control button 138 labeled “View Memorial Sponsorship Report”. The account holder may disable third-party payments by clicking on the control button 140 labeled “Do Not Accept Sponsorships”.

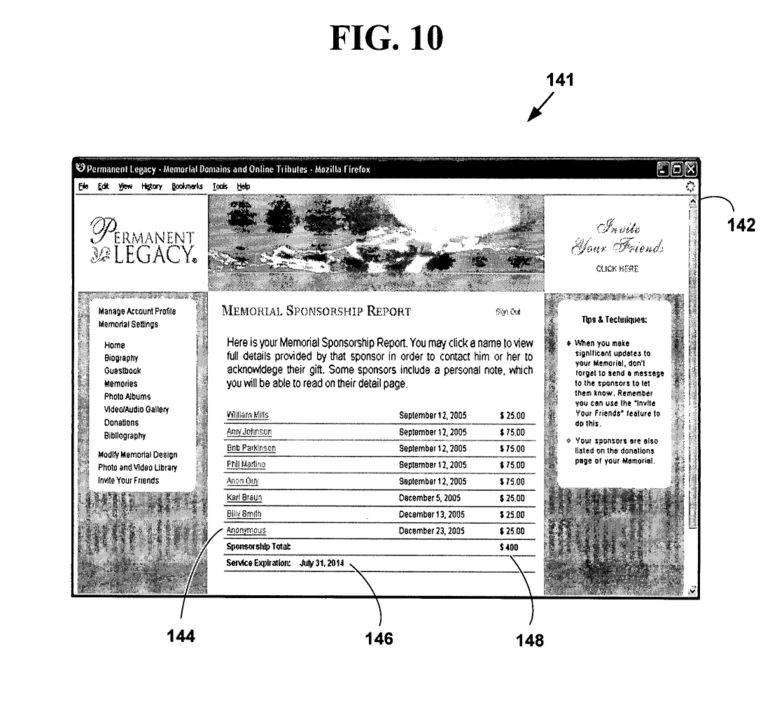

FIG. 10 is a block diagram 141 of a screen shot 142 that illustrates an exemplary summary report of third-party payments on behalf of the account holder's account. The information displayed by this report is recorded by and is provided by the third-party payment system 110. In this embodiment, the summary information 144 on each line shows the name, date and amount of payment, wherein the name is hyperlinked to a detailed report for that third-party payer. The third-party payment total 146 is displayed along with the current expiration date 148.

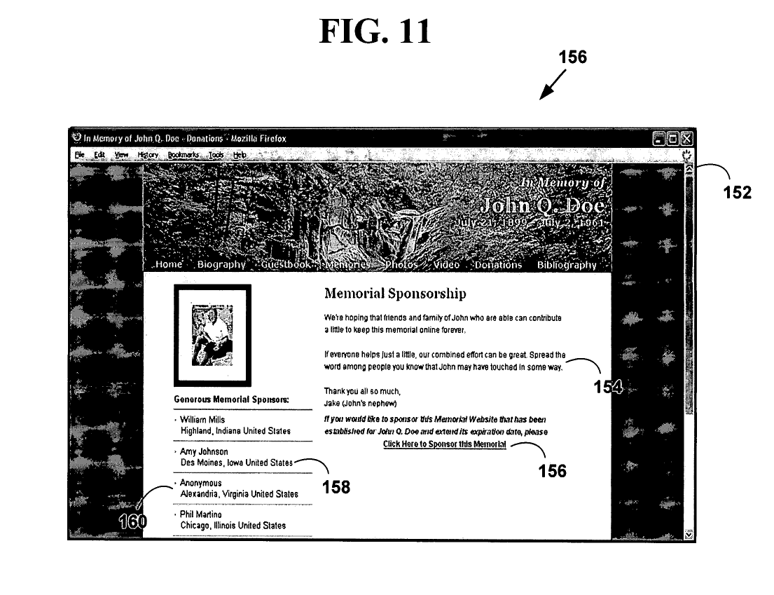

FIG. 11 is a block diagram 150 of a screen shoot 152 of an exemplary embodiment of a third-party payment interface 114 on the account holder's 120 website. A message 116 from the account holder 120 is displayed. The text that was entered in the message box 134 is displayed here. In this embodiment, the third-party payment system 110 displays a list 158 of third-party payers that have extended the life of this website, wherein anonymous entries 160 may be permitted.

In this exemplary embodiment, visitors that wish to become third-party payers will click on the text link 154 labeled “Click Here to Sponsor this Memorial”. When the third-party payer 118 clicks on that link, the third-party payment page.

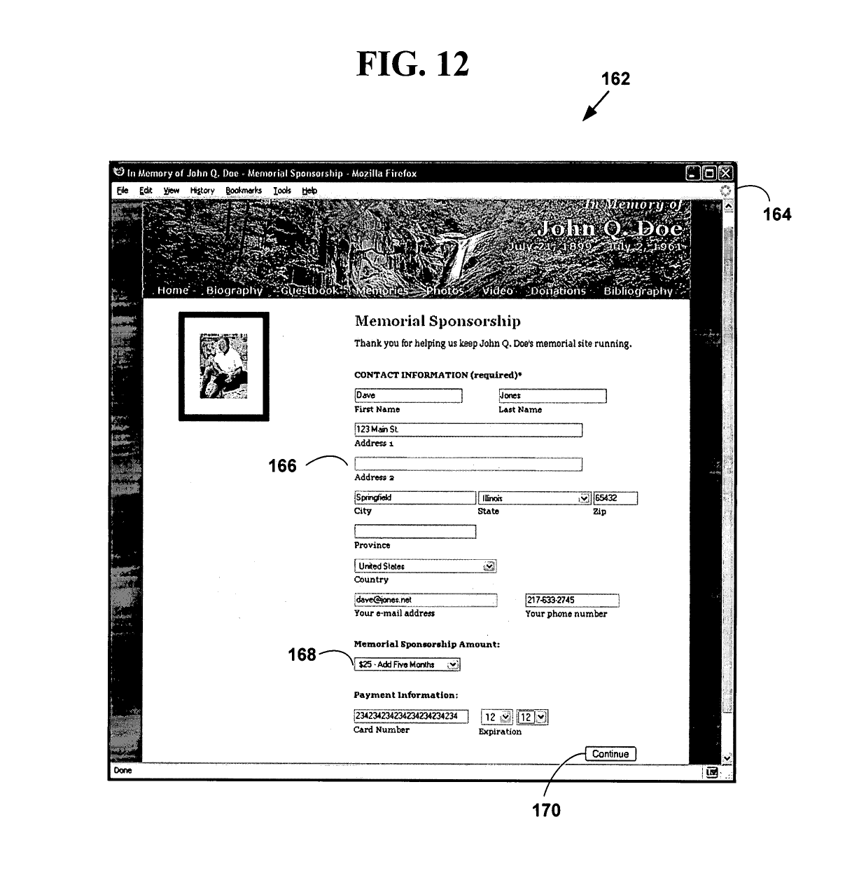

FIG. 12 is a block diagram 162 of a screen shot 164 illustrating a third party payment page. The third-party payment page is displayed and the payer provides payment information 166 and selects an option for payment amount and service term covered 168, then hits the Continue button 170 to proceed with the payment.

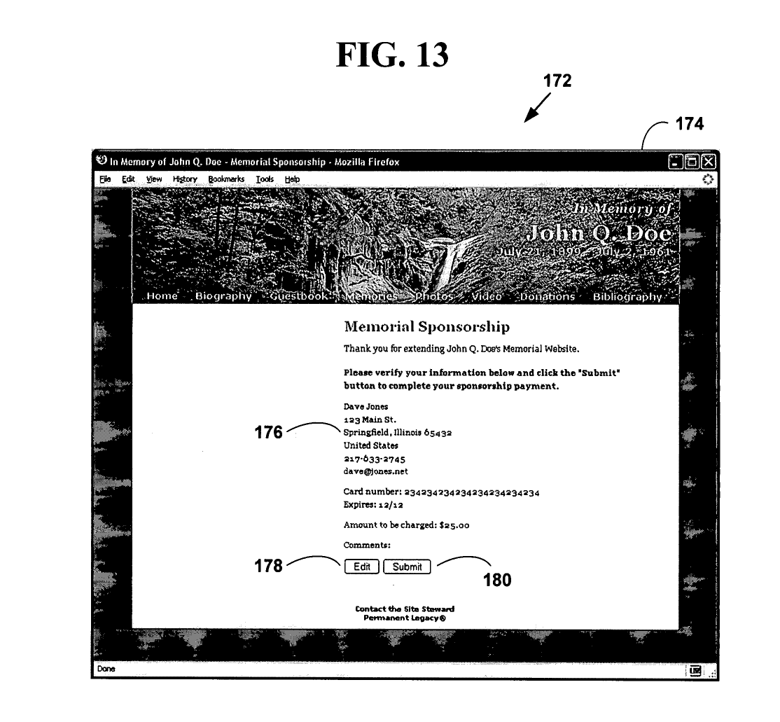

FIG. 13 is a block diagram 172 of a screen shot 174 of a third-party payment confirmation. The payment confirmation screen 174 displayed. The third-party payer 118 reviews the payment information 176 and clicks on the Edit button 178 to make any corrections, or if everything is correct, clicks on the Submit button 180 to submit the payment to the third-party payment system.

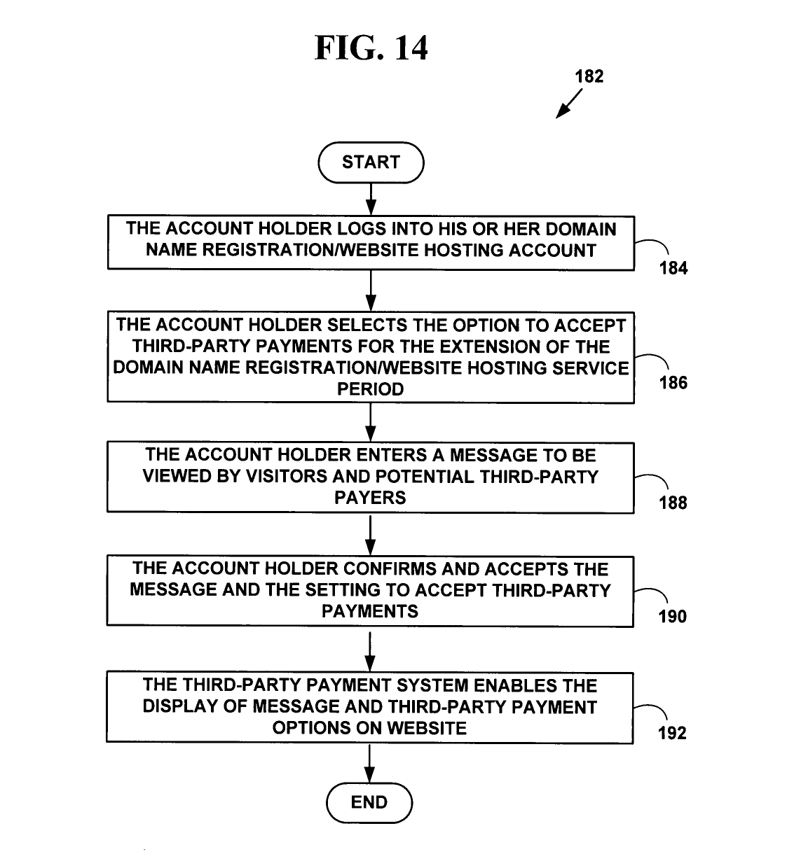

FIG. 14 is a flow diagram illustrating a Method 182 for enabling an account holder 120 to accept third-party payments as a means of extending the service period of domain registration and website hosting service. At Step 184, the account holder 120 logs in to an account. At Step 186, the account holder then selects the option to accept third-party payments, also illustrated in FIG. 8. At Step 188, the account holder 120 enters a message to be recorded by the third-party payment system 110. At Step 190, confirmation of the settings are accepted by the account holder. At Step 192, the third-party payment system 110 enables the display of third-party payment options interface 114 on the account holder's website 112.

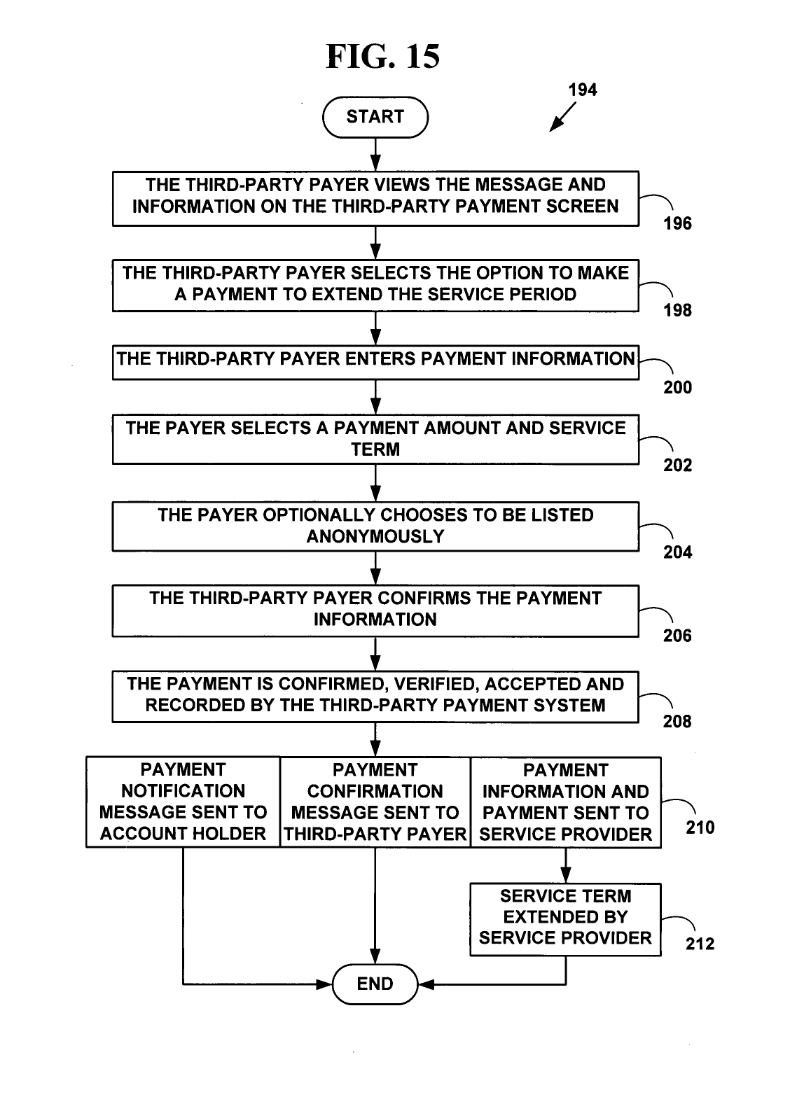

FIG. 15 is a flow diagram illustration a Method 194 for a third-party payment to be received, recorded and applied to the account holder's service period. At Step 196, the third-party payer 118 visits the account holder's website 112 and views the third-party payment interface 114. At Step 198, the third-party payer selects the option to make a payment to extend the service period. At Step 200, the third-party payer proceeds to enter payment information. At Step 202, the third-party payer selects a payment amount and service term or at Step 204 optionally chooses to make the payment anonymously. When the third-party payer chooses to remain anonymous, he or she may selectively chose to remain anonymous in the public display on the third-party payments section of the account holder's website and also in the report 144 that the third-party payment system provides to the account holder. After completing the payment sections, at Step 206 the third-party payer confirms the information. At Step 208 the third-party payment system 110 verifies and accepts records the payment. Upon accepting and recording the payment, At Step 210 a payment notification is sent to the account holder, a payment confirmation message is sent to the third-party payer, and payment information and payment are forwarded to the service provider. At Step 212, upon receipt of third-party payment, the service provider extends the service period.

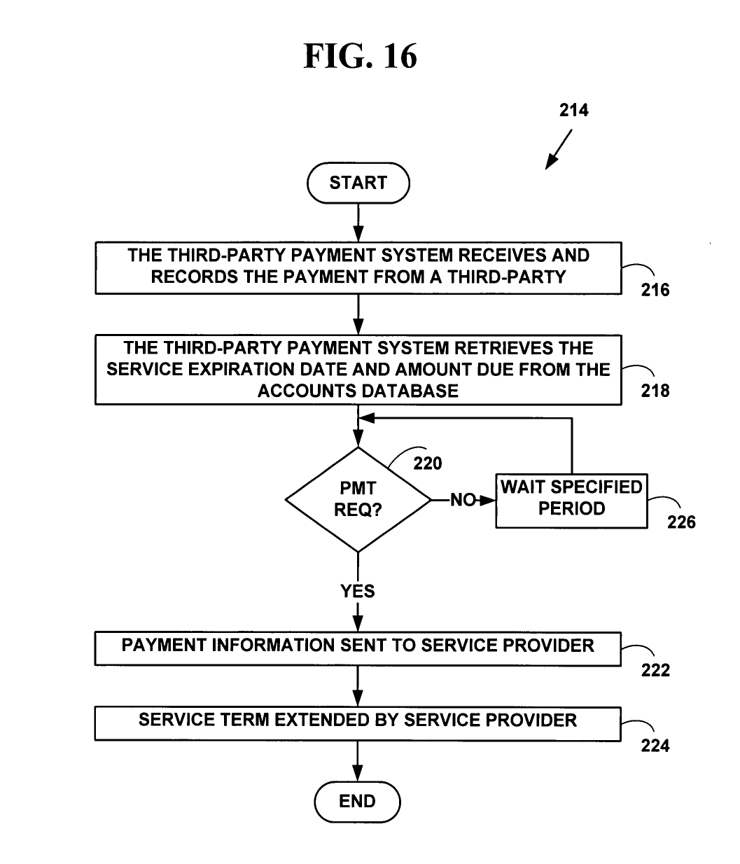

FIG. 16 is a flow diagram illustrating a Method 214 for third-party payments. In this embodiment, At Step 216, a payment is received, verified and recorded by the third-party payment system. However, instead of immediately forwarding the payment to the service provider, at Step 218 the third-party payment system first checks the service expiration dates for the account holder. At Step 220, a test is conducted to determine if a payment is required. If a payment is required, at Step 222 a payment is sent to the service provider and the service provider. At Step 224, the service provider extends the term of service. If a payment is not required at Step 224, At Step 226, the payment system will wait a specified period and repeat Step 220. In a variation of this embodiment, an expiration date retrieved at Step 220 is used to schedule an automatic payment to be sent to the service provider. The time periods used are configured to whatever is appropriate for a given environment (e.g., 1 year, 5 years, 10 years, etc).

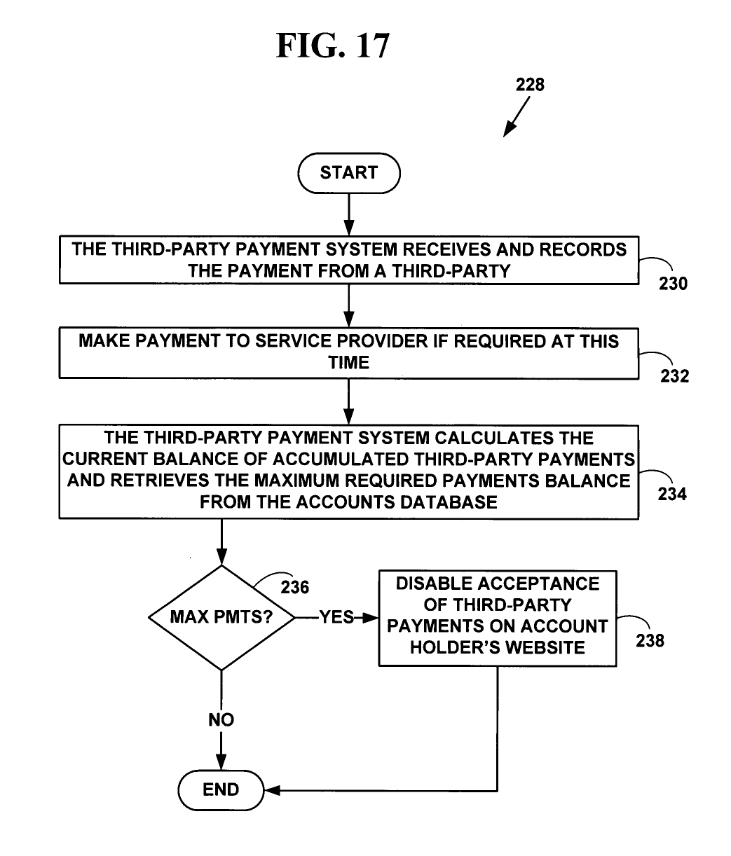

FIG. 17 is a flow diagram illustrating a Method 228 for third-party payments. In this embodiment, the third-party payment system 110 detects when a sufficient or maximum level of funds have been collected from third-party payers. At Step 230, the third-party system 110 receives and records of payment from a third party payer 118. At Step 232, the payment system 110 makes a payment to the service provider if required. At Step 234, the payment system 110 calculates a balance of accumulated funds to determine if a maximum required level of accumulated funds has been reached. At Step 236, a test is conducted to determine is a maximum payment level has been reached. If the maximum level has been reached, at Step 238 the third-party payments section on the account holder's website is disabled, otherwise, no action is taken. The reason for this check and for the possible disabling of third-party payments is that it is possible for the accumulated funds to be invested and to reach a point where they are generating sufficient income from interest or other return on investment where the required fees for domain name registration and website hosting can be paid in perpetuity, based on reasonable expectations of service cost and investment returns. If in the future, expectations of cost and returns were wrong, and the income produced by the accumulated funds becomes insufficient to pay the ongoing fees, the third-party payment system may reactivate the third-party payment section on the account holder's website.

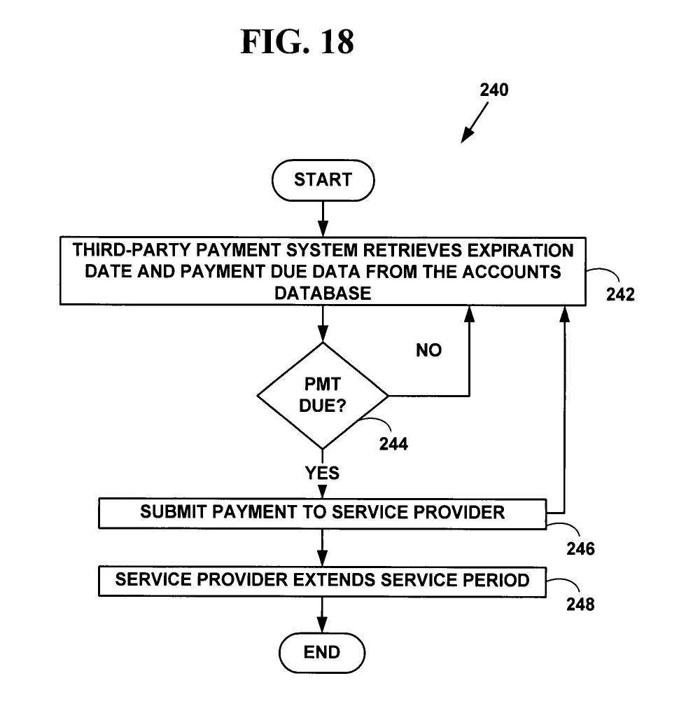

FIG. 18 is a flow diagram that shows a Method 240 for maintaining payments for domain registration service and website hosting service in perpetuity for the account holder. This Method 240 is utilized when the maximum required level of accumulated payments has been reached as illustrated in FIG. 17. Sufficient income exists to pay domain registration and website hosting fees to the service provider without collecting further payments from the account holder or third parties. With these conditions, At Step 242 the third-party payment system periodically retrieves expiration dates and amounts due from its accounts database. At Step 244 a test is conducted to determine if a payment is due. If no payment is due, Step 242 is repeated and the payment system returns to wait the period until the next check of expiration dates and amounts due is to be performed. If a payment is due, Step 246 the payment is submitted to the service provider and at Step 248 the service provider extends the service period.

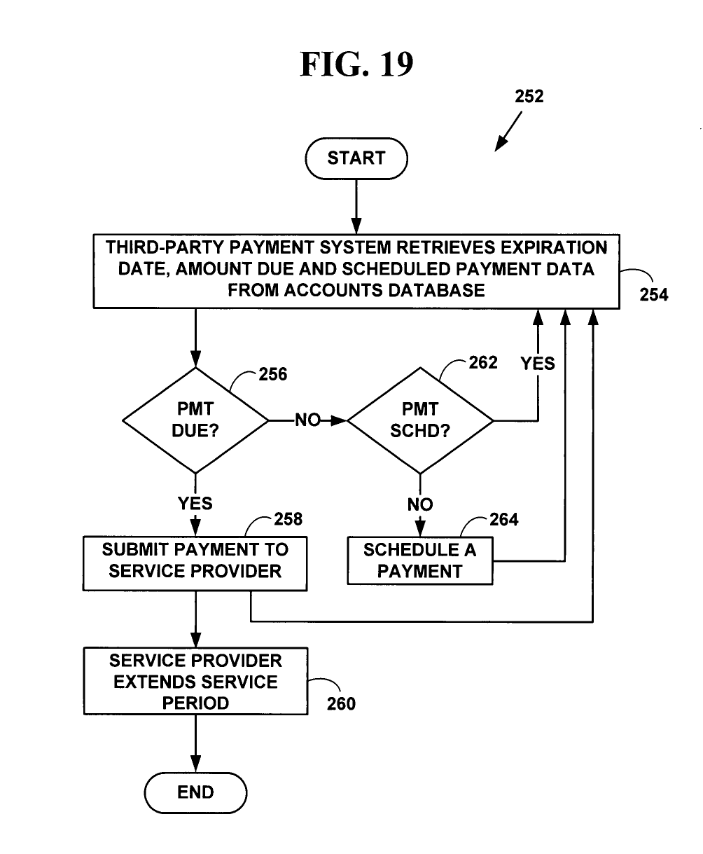

FIG. 19 is a flow diagram that shows a Method 252 which is another embodiment for maintaining payments for domain registration service and website hosting service in perpetuity for the account holder. As with Method 240, this method is utilized when the maximum required level of accumulated payments has been reached. At Step 254, the third-party system periodically retrieves expiration dates, amounts due, and scheduled payments from its accounts database. At Steps 256 a test is conducted to determine if a payment is due. If a payment is due, at Step 258 the payment system submits a payment to the service provider and returns to wait the period until the next check is performed. At Step 260, the service provider extends the service period for domain registration and website hosting for this account holder. If no payment is due, at Step 262, a test is conducted to determine if there is an automatic payment scheduled for this account holder. If no payment is scheduled, at Step 264 the system schedules an automatic payment based on pre-defined criteria retrieved from the accounts database. If a payment has already been scheduled the system returns to wait the period until the next check is performed

The flow diagrams illustrated in FIG. 18 and FIG. 19 do not have End statements intentionally to represent the non-ending nature of these Methods. These Methods could be applied even when the maximum level of accumulated funds has not been reached; however, with insufficient funds, the system will not operate in perpetuity and it is possible that the domain registration service and website hosting service will expire if additional account holder or third-party payments are not received.

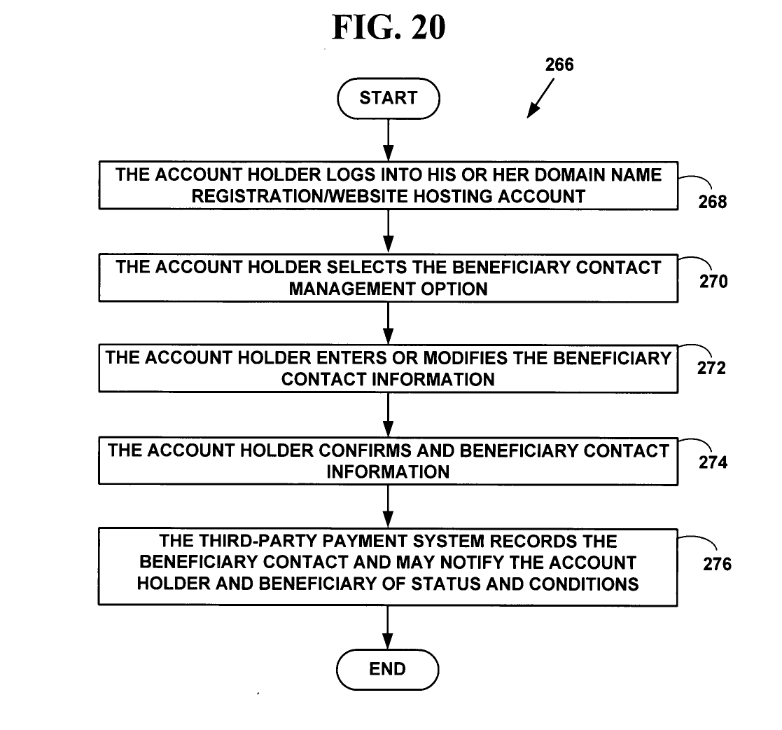

FIG. 20 is a flow diagram illustrating a Method 266 for providing for a beneficiary to be designated and recorded for the account holder's accounts. An account holder may wish to establish a beneficiary for the service account to avoid potential issues of ownership or access in case the account holder is unable to act. In this embodiment, At Step 268, the account holder logs in to the service account. At Step 270, the account holder chooses an option to set or update the beneficiary contact information. At Step 272, the account holder then enters the beneficiary contact information. At Step 274 the account holder confirms the beneficiary contact information. At Step 276, the third-party payment system and/or the service provider record the updated beneficiary contact information and may send confirmation messages to the account holder and the beneficiary contact for further confirmation.

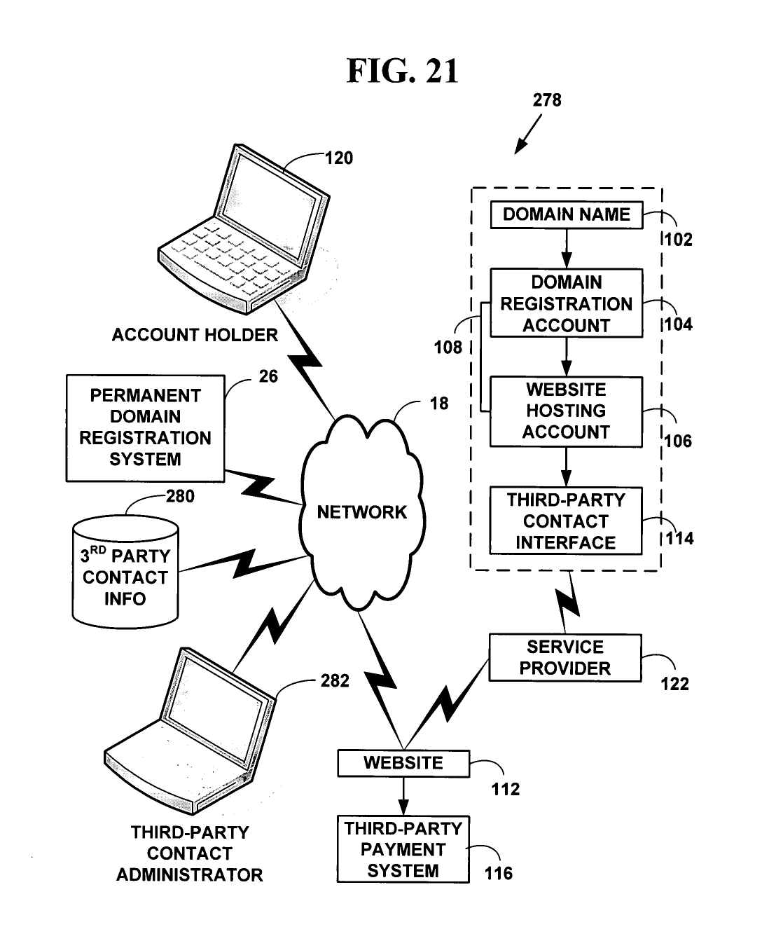

FIG. 21 is a block diagram illustrating an exemplary third-party contact system 278 for remotely maintaining contact information on a web site. The system 278 includes, but it not limited to a communications network 18 that interconnects the components, a domain name 102, a domain registration account 104 and website hosting account 106, or a combined domain registration and website hosting account 108, where third-party payment contact management functionality is incorporated. A website 112 that resides at the address indicated by the associated domain name 102, wherein functionality to display third-party contacts interface 114 is incorporated. A third-party contact database 280, one or more third-party contact database administrators 282, and an account holder 12—domain name registration and website hosting account. A service provider 122 provides the underlying service to the account holder that maintains the accounts and the website and access to them. The third-party contact administrator could directly updating their own contact information through shared access to the third-party contact database or the contact administrator could be an organization or individual that maintains the third-party contact database on behalf of the individuals or organizations in the database. The third-party contact system 278 also includes the domain name protection systems 10 data flow 54 (FIGS. 1 and 4).

The third-party payment interface allows holder of a domain name registration service or website hosting service to record and assign a beneficiary who will become the legal holder and/or trustee of the website hosting and/or domain registration account under specified conditions. The third-party payment interface also allows the account holder to select a contact from a third-party source to add to their website, to be displayed in a public or private area of that website.

Table 2 illustrates exemplary actions of components of the methods and systems described herein. However, the present invention is not limited to such an embodiment and other actions can also be used to practice the invention.

TABLE 2
Account holder:
Can enable or disable collection of third-party payments
Can provide detailed message to third-parties describing purpose
of payment
Can view payment details provided by payment system
Can receive messages of payment from payment system
Can observe that the expiration date for their account has been extended
Third-party Payment System:
Can transmit payments + service info to service provider
Can track maximum needed
Can collect payment information
Can record transactions
Can receive payment info, amt, service contract
Transmits messages to receiver, payer
Service provider:
Accepts payment from 3^{rd} party or payment system for service
Extends service term by amount paid
Website:
can be enabled by account holder to accept third-party payments
display option to third-parties to make payment
display message (if exists) from account holder
when enabled, display third-party sponsorship payors
allow third-party sponsorship payors to remain anonymous
go to a payment screen
Making the payment:
Third party clicks to make payment
Chooses a period to sponsor and the corresponding amount
Chooses to be anonymous or not
Click on accept payment terms and proceed to payment system
Enter Contact info
Approve Payment
The Third Party Payment System:
Payment system accepts third-party payment
Payment system records transaction details
Transmits a message to account holder
Transmits a message to the sponsor
Account holder is allowed to review report of details of all transactions
Account holder is allowed to review report of summary of all transactions
Transactions recorded so that third-party payor is displayed on a website
as a sponsor
Payment information and funds are transmitted to service provider and
expiration date is extended
Payment system may retain payments made and use interest generated by
retained payments to transfer to service provider to extend expiration date
Payment system retains payment and transmits payment when it is
required by the service provider (tracking info necessary)
Payment system retains funds and generated interest and/or other income
and used that income to issue payments to service provider.
A third party:
chooses to make a payment
chooses to remain anonymous
chooses a payment amount and service term

The third-party payment system assists in providing a permanent domain name registration service system or a permanent website hosting service system with third-party payments.

The present invention also includes assigning contacts from a third-party contact source. The account holder may select a third party contact from a database and cause that contact to be displayed on the website. When the contact information changes, the modifications are done at the third-party contact source and the changes appear immediately on the website without any need to access the account holder's account. Without limiting other possible uses for these methods, an example of the use of this method is with memorial websites. The third-party payment system can allow website to be hosted indefinitely, and a possible feature on a memorial website is a donations page where a favorite donation is listed. Over the long term, there is a good chance that some aspect of the contact information for a charitable organization may change. Using the third-party contact method, the updated charitable organization contact information will always display the contacts stored in the third-party contact database.

The method and system described herein extend domain name registration service website hosting service with a third-party payment system. A third-party payment system enables a domain name/website hosting account holder to accept third-party payments; third parties may then view a payment section on their website and choose to make a payment for a specified period. The third-party payment system manages the funds and tracks the need to accept third-party payments and to make timely payments to the service provider. A beneficiary contact and a third-party contact method are included as means to help manage a website that may operate unattended and may remain online indefinitely.

It should be understood that the programs, processes, methods and system described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments including hardware or firmware implementations, or combinations thereof, may alternatively be used, and visa versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A method for perpetually extending a term of a domain registration service or website hosting service by a third-party payment system, comprising:
allowing an account holder using a domain name registration service or a website hosting service to enable third-party payments for extending a domain name registration service period or a website hosting service period perpetually wherein enabling third-party payments allows a third-party payment interface to be displayed on the account holder's website;
accepting a payment from a third-party through the third-party payment interface on the account holder's website via a third-party payment system;
recording payment details in a database associated with the third-party system,
wherein the third-party payment system automatically forwards the accepted payment to one or more service providers providing the domain name registration service or website hosting service,
wherein the one or more service providers extend the service termination date for the domain name registration service or website hosting service, and
wherein one or more accepted third-party payments are used to perpetually pay all future renewal fees for the domain name registration service or website hosting service, thereby providing permanent domain name registration or permanent website hosting.

2. The method of claim 1 further comprising a computer readable medium having stored therein instructions for causing one or more processors to execute the steps of the method.

3. The method of claim 1 wherein the third-party payment system includes an accounts database for maintaining, recording, monitoring and tracking domain name registration services or website hosting services data including expiration dates, amounts due, payments made, scheduled payments, contact details and tracking and access information.

4. The method of claim 1 further comprising:
receiving on the third-party payment system the accepted payment; and
accessing a database to verify if a payment is due, and if so, submitting payment to the one or more service providers, and if not holding the accepted payment in an income producing investment until a payment is required.

5. The method of claim 4 further comprising:
determining if an accumulated balance of accepted payments is at a sufficient level such that all future payments can be made from income produced by the income producing investment perpetually, and if so,
automatically disabling the third-party payment interface from display on the account holder's website, thereby not allowing the acceptance of any further third-party payments.

6. The method of claim 1 further comprising:
accepting from the account holder enter a personalized message on the third-party payment interface when enabling third-party payments, the message being directed at third-party payers and potential third-party payers and this message will be displayed on the third-party payment interface on the account holder's website.

7. The method of claim 1 wherein the third-party payment system sends the account holder a notification that a third-party payment has been received.

8. The method of claim 1 further comprising:
displaying a list of third-party payers on the third-party payment interface as sponsors of the account holder.

9. The method of claim 8 wherein the third-party payment interface allows third-party payers to elect to be displayed on the account holder's website as anonymous sponsors.

10. The method of claim 1 wherein the account holder's website is a memorial website for a deceased person or pet.

11. The method of claim 10 wherein the memorial website is maintained perpetually by investing the accepted payment in an income producing investment.

12. The method of claim 1 wherein the account holder may view via third-party payment interface summary and detailed reports of all third-party payments made including third-party payer name, address, email, phone number, amount, personal note, a total of all third-party payments received, balance of any accumulated funds and proximity to reaching the maximum required level of accumulated funds, and the new expiration date after receipt of all payments.

13. The method of claim 1 wherein the third-party payment interface displays a current expiration date of the account holder's domain name registration service or website hosting service is displayed to potential third-party payers.

14. The method of claim 1 further comprising:
automatically detecting on the third-party payment system that an accumulated balance of accepted payments has decreased below a pre-determined threshold necessary for maintaining perpetual payments for the domain name registration service or website hosting service due to poor performance of income producing investment used to invest the accepted payments; and
automatically re-enabling the third-party payments interface on the account holder's website after having previously disabled the third-party payment interface on the account holder's website thereby allowing additional third-party payments to be accepted.

15. The method of claim 1 wherein the third-party payment interface allows holder of a domain name registration service or website hosting service to record and assign a beneficiary who will become the legal holder and/or trustee of the website hosting and/or domain registration account under specified conditions.

16. The method of claim 1 wherein the third-party payment interface allows the account holder to select a contact from a third-party source to add to their website, to be displayed in a public or private area of that website.

17. The method of claim 1 wherein the third-party payment system provides a permanent domain name registration service system or a permanent website hosting service system.

18. A permanent domain name registration system for perpetually extending a term of a domain registration service or website hosting service by a third-party payment system, comprising in combination:
third-party payment enablement means for allowing an account holder using a domain name registration service or a website hosting service to enable third-party payments for extending a domain name registration service period or a website hosting service period perpetually;
third-party payment interface means for displaying third-party payment information on the account holder's website and for accepting payments from third-parties;
third-party payment acceptance means for accepting a payment from a third-party through the third-party payment interface means on the account holder's website, for recording payment details in a database associated with the third-party system, for automatically forwarding the accepted payment to one or more service providers providing the domain name registration service or website hosting service, wherein the one or more service providers extend the service termination date for the domain name registration service or website hosting service, and wherein one or more accepted third-party payments are used to automatically and perpetually pay all future renewal fees for the domain name registration service or website hosting service, thereby providing permanent domain name registration or permanent website hosting.

19. The system of claim 18 wherein the account holder's website is a memorial website for a deceased person or pet.

20. The system of claim 18 wherein the third-party payment acceptance means automatically perpetually pays the or more service providers to provide a permanent domain name registration or permanent website hosting for the account holder.
